(19) United States
(12) Patent Application Publication
(10) Pub. No.: US 2003/0127235 A1
(43) Pub. Date: Jul. 10, 2003

(54) Ground preparation device

(76) Inventor: Helmut Dannigkeit, Battweiler (DE)

Correspondence Address: Duane A Coordes, Deere & Company, Patent Department, One John Deere Place, Moline, IL, 61265-8098, US

(21) Appl. No.: 10/311,032

(22) PCT Filed: Jun. 2, 2001
(86) PCT No.: PCT/EP01/06330

(30) Foreign Application Priority Data
Jun. 10, 2000 (DE) 100 28 930.4

(51) Int. Cl. A01B 41/06

(52) U.S. Cl. 172/2

(57) ABSTRACT

The invention pertains to a soil cultivation device (8) with a frame (10) to which at least one soil cultivation tool and wheels (14) rolling upon the soil are attached, where the position of the wheels (14) and/or of the soil cultivation tool can be varied relative to the frame by means of a hydraulic cylinder (24, 80) and can be ascertained by a sensor (58). In order to improve the operating dependability of the sensor, it is proposed that the sensor (58) be located within the housing (48) of the hydraulic cylinder (24, 80). In addition, a pivoting tow-bar (12) can be located on the frame (10), with which the soil cultivation device (8) can be coupled to a tractor vehicle, and in order to level the frame (10), the tow-bar (12) can pivot relative to the frame (10) by means of an additional hydraulic cylinder (40).

The invention pertains to a soil cultivation device with a frame to which at least one soil cultivation tool with wheels rolling upon the soil is attached, where the position of the wheels and/or of the soil cultivation tool can be varied relative to the frame by means of a hydraulic cylinder and can be ascertained by a sensor.

In document EP 0 916 244 A a soil cultivation device is proposed whose fundamental design consists of a frame and soil cultivation tools attached thereto. The height of the frame above the soil—and thus the working depth of the soil cultivation tools—is defined by wheels rolling upon the soil, said wheels are height-adjustable and articulated to the frame and moveable by means of hydraulic cylinders. For adjusting of the desired position of the hydraulic cylinder, the position of the wheels can be determined by measurement converters in the form of potentiometers. The potentiometers are turned by means of their allocated pivot mechanisms.

In U.S. Pat. No. 4,413,685 A a seed sowing device is described with several sowing units. The position of the furrow opening of a sowing unit attached to the frame of the sowing device, which is adjustable by a hydraulic cylinder, is ascertained by means of a potentiometer. The potentiometer is mounted to the frame and its slider is turned by a linkage attached to the sowing device.

One disadvantage of the known devices for measuring (and regulating) the height of a soil cultivation device or tool above the ground resides in the fragility of the potentiometer and of the mechanisms which are used for its adjustment. When working on a field with a soil cultivation device, under dry conditions, dust will collect on the potentiometer and on its adjusting mechanism. If conditions are wet, then spattered mud, harvest residues, moisture and other kinds of dirt will collect thereon. If the potentiometer is not entirely encapsulated, then only a short service life can be expected. And also a dirtied and thus no longer satisfactorily moving mechanism to adjust the potentiometer will prevent an orderly functioning of the device for measuring the height or ground clearance.

The problem underlying the invention is to create a soil cultivation device with a dependably operating device to measure the position of a wheel or of a soil cultivation tool.

This problem is solved according to this invention by the embodiment of claim 1, whereas in the additional claims, properties are listed which refine the design in a favorable manner.

It is proposed to integrate the sensor for determining the position of the wheels or of the soil cultivation tool opposite the frame into the housing of the hydraulic cylinder. The sensor will be shielded there against dust, moisture and other dirt and will determine the position of the piston of the hydraulic cylinder or of an element connected to the piston. Since the hydraulic cylinder is used for adjusting the wheels or the soil cultivation tool, the position of its piston is a measure of the location of the wheels or of the soil cultivation tool with respect to the frame.

In this manner we obtain a soil cultivation device whose equipment for measuring (and preferably for controlling) the position of a wheel or of a soil cultivation tool relative to the frame will operate in a fault-proof manner and will exhibit a long service life. The number of moving parts is thus reduced because the linkage of the potentiometer is omitted.

As already explained, the hydraulic cylinder can define the depth of penetration of a soil cultivation tool into the soil, since a mount of the soil cultivation tool is pivoted or displaced relative to the frame. Alternatively or additionally, the height of the frame above the ground is specified since the wheel or several wheels are height-adjusted by the hydraulic cylinder relative to the frame, that is, it is (or they are) displaced or pivoted. It must be taken into account that the frame as a rule, is level in spite of the height adjustment, i.e., it is to remain oriented in parallel to the surface of the ground. For this purpose, the soil cultivation device, for example, can be equipped with four wheels, with two each located side by side and one pair one behind the other. The wheels are adjusted by their allocated hydraulic cylinders (see EP 0 916 244 A). It is also possible to use only one hydraulic cylinder which adjusts all four wheels by means of a coupling linkage or such.

In a different design format, the soil cultivation device has only two (or more) wheels located side by side, and the slope of the frame forward to back is defined by the position of a tow-bar, with which the soil cultivation device is coupled to a tractor vehicle. In the state of the art (U.S. Pat. No. 5,450,908 A), a complicated linkage is used which couples the tow-bar to the hydraulic cylinder used for height adjustment of the wheels, and which maintains the horizontal alignment of the frame. In one preferred design format of the invention, in addition to the hydraulic cylinder for height adjustment of the wheels, an additional hydraulic cylinder is provided which can define the angle of the tow-bar relative to the frame, for leveling of the frame, and which can be supplied with hydraulic fluid so that the frame will always be oriented horizontally. We thus save the complicated linkage. In particular for controlling the position of the tow-bar, the hydraulic cylinder used for adjusting of the tow-bar can be equipped with a sensor integrated into its housing, which determines the position of its piston—and thus information about the location of the tow-bar. The sensor in this design format can also be located in a known manner outside the hydraulic cylinder, as also the sensor for the position of the wheel.

The output signal of the sensor or of the sensors can be sent to a control device which controls a valve which supplies hydraulic fluid to the hydraulic cylinder(s). In the actual case, the hydraulic cylinders can be brought into a position which corresponds to a setting specified by a user. If the hydraulic cylinder controls the setting of the wheels of the soil cultivation device, then the user can thus input the height of the frame above the soil. With this height, the operating depth will be defined for the soil cultivation tool attached to the frame (i.e., not adjustable by a hydraulic cylinder or such, but perhaps by spring-suspension). Also the slope of the frame can be varied by a user input when at least two hydraulic cylinders are provided, so that wheels located one behind the other can be varied, or the setting of a tow-bar and wheels located side by side can be varied. In addition, by means of a user input, the setting of a soil cultivation tool relative to the frame can be varied (and thus the working depth of the soil cultivation tool), provided a hydraulic cylinder is provided for this. For input of the desired values, a separate input device, or one already provided at the driver seat of the tractor vehicle can be used. The given or adjusted positions can be displayed for the user in a known manner.

As an alternative to an input provided by the user, it is also proposed that the control device control the hydraulic cylinder or cylinders. The necessary working depths can be saved according to the particular site on a map stored in a memory. When cultivating the field, the position of the soil cultivation device will be determined by a position determination device (usually a satellite-based system) and the particular working depth to be adjusted will be read off the map and put into effect. The saved, suitable working depth of the soil cultivation tool can depend on the type of soil, the amount of rainfall and/or other parameters.

Before travel on a road or at the end of a field, the frame can be lifted up by adjustment of the wheels, e.g., according to a particular input by the user into the input device or based on the position determined by an associated position determination device. It is possible to provide the input device with a key, a switch or similar item for actuation upon road travel, whose activation will cause the control device to perform the corresponding adjustments of the hydraulic cylinders. Also, a soil cultivation tool adjustable by a hydraulic cylinder can be lifted relative to the frame for road travel. If the soil cultivation vehicle is equipped only with wheels located side by side and with a separately pivoting tow-bar, then the latter can be pivoted for road travel so that the ground clearance of a soil cultivation tool located in the front or rear region of the soil cultivation device will be increased. The corresponding settings of the hydraulic cylinder can be saved in a memory.

The figures show two design examples of the invention which will be explained in greater detail below. We have:

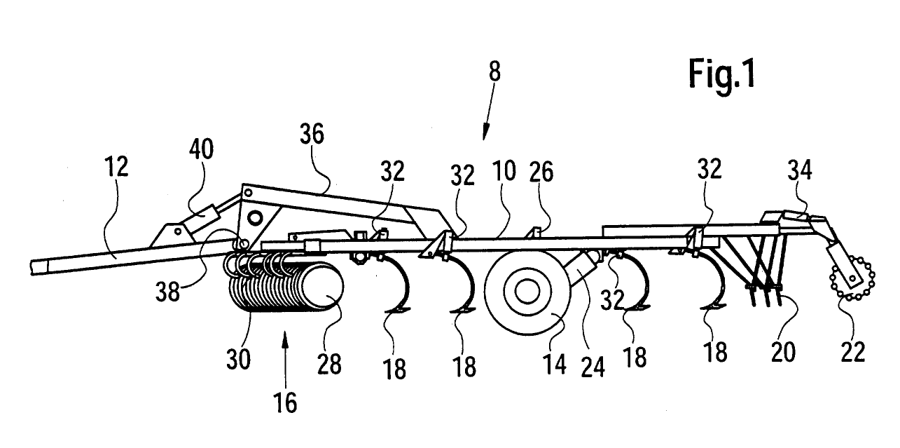

FIG. 1 is a soil cultivation device according to this invention;

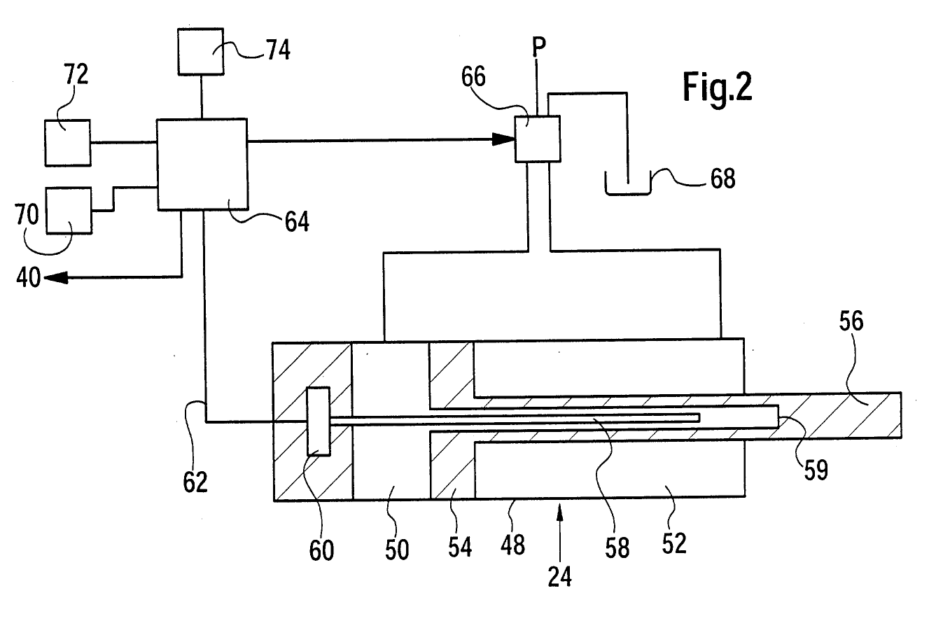

FIG. 2 is a hydraulic cylinder with sensor integrated into its housing and with a control circuit; and

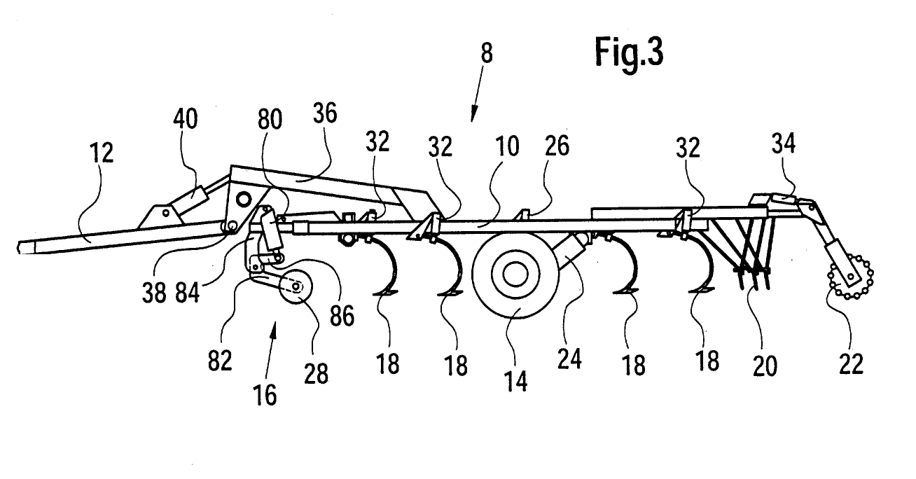

FIG. 3 is a second design format of a soil cultivation device.

In FIG. 1 there is a soil cultivation device 8 whose fundamental design consists of a frame 10, two wheels 14 located next to each other side by side and rolling upon the ground (only one of these wheels is visible in the drawing), a tow-bar 12 and also various soil cultivation tools 16 to 22.

The wheels 14 are height adjustable via a hydraulic cylinder and are attached to the frame 10. Adjustment of the wheels 14 takes place by means of the hydraulic cylinder 24 by pivoting of a strut (not visible in the drawing) articulated to the frame 10 by means of a spring 26. A suitable mechanism for adjustment of the wheels 14 is also disclosed in U.S. Pat. No. 5,450,908 A, which is incorporated herein by reference.

At the end of the frame 10 shown on the left in FIG. 1, at the front in the forward travel direction, the first soil cultivation tool is a disk harrow 16 with a row of disks 28 located side by side. The disk harrow 16 is attached to the frame 10 by springs 30. The disk harrow 16 is followed by four duckfoot plows 18 positioned one behind the other, which are attached by spring-action tool supports to the frame 10. Two duckfoot plows 18 are positioned respectively in front of and behind the wheels 14.

In the direction of forward travel behind the last duckfoot plows there is a rake 20 attached to the frame 10, which finally is followed by a tubular bar mill 22 as packer. The tubular bar mill 22 is pressed against the ground by the force of a hydraulic cylinder 34.

For coupling of the soil cultivation device 8 to a tractor vehicle (tractor) a forward-extending support 36 is attached to the frame 10, to which the tow-bar 12 is articulated to pivot about a horizontal axis 38 running transverse to the forward driving direction. A hydraulic cylinder 40 connects the tow-bar 12 with the support 36 and defines the slope of the tow-bar 12, and if said tow-bar is mounted to a tractor vehicle, said cylinder also defines the slope of the frame 10 in the direction of forward travel. As a rule, since the frame 10 is to be aligned (leveled) horizontal, then the tow-bar 12 and the wheels 14 can pivot synchronously into the desired position due to the hydraulic cylinders 40, 24 allocated to them. Due to the use of two hydraulic cylinders 24, 40, a coupling between the tow-bar 12 and wheels 14 is not needed.

The soil cultivation device 8 is illustrated in the transport position in FIG. 1, in which it can be pulled along a roadway by using a tractor vehicle. Before operation on a field, the wheels 14 are lifted by the hydraulic cylinder 14 [sic; 24] with respect to the frame 10 and the tow-bar 12 is pivoted upward about the axis 38, so that the frame 10 is lowered and the soil cultivation devices engage with the soil of the field. Also the tubular bar mill 22 is brought into contact with the ground due to its associated hydraulic cylinder 34. If the soil cultivation device 8 is pulled across the field by the tractor vehicle, then the disk harrow 16 will break open the soil. The duckfoot plows 18 cut off the roots of plants at a level defined by their operating depth. The rake 20 smoothes out the soil thrown up by the preceding cultivation steps and finally, the tubular bar mill 22 compacts it again. The soil cultivation tools 16 to 22 are rigid, that is, except for their spring mounts 30, 32, they are attached to the frame 10 and cannot be adjusted. Their working depth is thus defined only through the position of the wheels 14 and of the tow-bar 12 relative to the frame 10. The working depth or the pressure of the tubular bar mill 22 is specified by the hydraulic cylinder 34.

In FIG. 2 we see the hydraulic cylinder 24 and its associated control circuit 64. A piston surface compression space 50 and a piston rod compression space 52 in a housing 48 are separated from each other by a sliding piston 54. The piston 54 is connected to a piston rod 56. In FIG. 1, the housing 50 [sic; 48] is connected to the frame 10 of the soil cultivation device 8, whereas the piston rod 56 is connected to the wheel 14.

A sensor 58 extends into a drilled hole which is drilled in the piston 54 and the piston rod 56; this sensor determines the particular position of the piston 54 in the housing 48. The mode of operation of the sensor 58 can be of any particular type; for example, it could measure the transit time of a pressure wave transmitted from a tip to the base 59 of the hole and back. It is also possible for the sensor 58 to have a coil extending over its entire length with its inductivity dependent upon and measured by the position of the piston 54. Also, a capacitive determination of the position of the piston 54 by the sensor 58 is possible. Within the housing 48 there is also an integrated electronic evaluation system 60 which provides an output signal to a line 62 and this signal contains information about the location of the piston 54.

The line 62 is connected to a control circuit 64 which drives a valve 66. The valve 66 is connected to a source P of pressurized hydraulic fluid, a sump 68, the piston compression space 50 and the piston rod compression space 52.

Moreover, the control circuit 64 is connected to an input device 70, which as a rule, can be operated from the driver position of a tractor vehicle. The input device 70 makes it possible to input a particular working depth. The input device 70 can be designed in the form of a keyboard with an associated video display or as a touch-sensitive video display (touch screen).

Information is stored in the control circuit 64 in the form of a table, mathematical function or similar means which corresponds the setting of the hydraulic cylinders 24 and 40 to a working depth input at that particular time. In case of a change in working depth, the control circuit will first determine what setting the hydraulic cylinders 24, 40 are to take on.

The control circuit 64 controls the valve 66 which connects the piston surface compression space 50 or the piston rod compression space 52 of the hydraulic cylinder 24 to the source P and drains the hydraulic cylinder from the other compression space into the sump 68, so that the piston 54 will move into the desired direction. Now if a comparison of the position determined by the control circuit 64 with that position ascertained by the sensor 58 shows that the desired position of the piston 54 has been reached, then the compression spaces of the hydraulic cylinder 24 will again be blocked. The sensor 58 in its shielded configuration in the housing 48 thus makes it possible to have an active control of the hydraulic cylinder 24 for setting the desired operating depth of the soil cultivation device 8. It should be mentioned that a description of this kind of hydraulic cylinder and of a suitable control system is found in DE 197 47 949 A, which is incorporated herein by reference.

The hydraulic cylinder 40 allocated to the tow-bar 12 has a design which corresponds to the hydraulic cylinder illustrated in FIG. 2 and it is likewise controlled by a control circuit 64 in the manner to be described below, where the two hydraulic cylinders 24, 40 are moved preferably at the same time (or alternately, in sequence, each moving by a short distance) while maintaining an at least approximately horizontal orientation of the frame 10. Also, the hydraulic cylinder 34 of the tubular bar mill 22 is controlled in the manner described.

The input device 70 can also be used to select a second operating mode of the control circuit 64. In the second operating mode, by means of an antenna 74 operating with the so-called Global Positioning System, it is possible to determine the position of the tractor vehicle. With a known position of the tractor vehicle and a known direction and speed of travel, the position of the soil cultivation device can be calculated precisely in order to increase accuracy. It is also possible to allocate the antenna 74 to the soil cultivation device 8 in order to eliminate the position conversion from tractor vehicle to the soil cultivation device 8. A map is stored in a memory 72 on which an expedient working depth is entered as a geo-reference. Based on the position determined by the antenna 74, the particular working depth to be used will be read out of the memory 72. The control circuit 64 then controls the hydraulic cylinders 24, 34, 40, so that the operation will proceed at the determined operating depth.

FIG. 3 presents a second design format of the soil cultivation device 8, where the same elements in FIGS. 1 and 3 are identified with consistent reference numbers. The soil cultivation device in FIG. 3 corresponds essentially to that of FIG. 1, but differs with regard to the mounting of the disk harrow 16. The disks 28 of the disk harrow 16 are rotary-mounted to a rocker arm 82 which is articulated to and pivots on a strut 84, which is attached to the frame 10. The rocker arm 82 is connected to a pivot arm 86 to which a hydraulic cylinder 80 is articulated. The other end of the hydraulic cylinder 80 is attached to the frame 10. Consequently, the disk harrow 16 can pivot with respect to the frame 10 by means of the hydraulic cylinder 80 and is thus height-adjustable.

The hydraulic cylinder 80 corresponds in design and functionality to the hydraulic cylinder 24 shown in FIG. 2. It makes it possible to adjust the distance of the disk harrow 16 from the frame 10 and thus its working depth, independently of the working depth of the duckfoot plows 18, of the rake 20 and of the tubular rod roller 22. Thus, the disk harrow can be adjusted to a working depth optimally adapted to the particular soil conditions. The working depth of the disk harrow 16 can be input by the user or it can be geo-referenced and saved in advance. An additional advantage of this design format rests in the fact that the disk harrow 16 can be elevated into its highest-possible position in order to increase the ground clearance during road travel or at the end of the field. It is also possible during road travel with elevated disk harrow 16, to extend the hydraulic cylinder 40 allocated to the tow-bar 12, in order to position the disk harrow 16 as high as possible above the ground. But in this case, the tubular bar mill 22 must still have enough ground clearance, which can be ensured by a corresponding control of the hydraulic cylinder 34 allocated to it. The settings of the hydraulic cylinders 24, 34, 40 and 80 for road travel can be saved in the memory 72 and then can be called up by the user by means of the input device 70.

Finally, it should be mentioned that it would also be possible to use only a spring—in a known manner-instead of the hydraulic cylinder 34, for adjusting the working depth or for lifting the tubular bar mill 22.

1. Soil cultivation device (8) with a frame (10) to which at least one soil cultivation tool and wheels (14) rolling upon the soil are attached, where the position of the wheels (14) and/or of the soil cultivation tool can be varied relative to the frame by means of a hydraulic cylinder (24, 80) and can be ascertained by a sensor (58), characterized in that the sensor (58) is located within the housing (48) of the hydraulic cylinder (24, 80).

2. Soil cultivation device (8) according to claim 1, characterized in that a pivoting tow-bar (12) is located on the frame (10), with which [tow-bar] the soil cultivation device (8) can be coupled to a tractor vehicle, and that the tow-bar (12) can pivot relative to the frame (10) by means of an additional hydraulic cylinder (40), in particular for leveling of the frame (10).

3. Soil cultivation device (8) according to claim 2, characterized in that a sensor (58) is provided within the housing (48) of the hydraulic cylinder (40) allocated to the tow-bar (12) in order to ascertain the position of the tow-bar (12) relative to the frame (10).

4. Soil cultivation device (8) according to one of the preceding claims, characterized in that an output signal of the sensor (58) is supplied to a control device (64) which is connected to a valve (66) which is set up with hydraulic fluid for actuation of the hydraulic cylinder (24, 34, 40, 80).

5. Soil cultivation device (8) according to claim 4, characterized in that the control device (64) controls the valve (66) so that the hydraulic cylinder (24, 34, 40, 80) will take on a position input by a user and/or saved as a geo-reference in a memory (72).

6. Soil cultivation device according to one of claims 4 or 5, characterized in that the control device (64) during road travel or at the end of a field will control the valve (66) so that the soil cultivation tool will be lifted up and the wheel (14) will be moved downward relative to the frame (10).

7. Soil cultivation device according to claim 6, characterized in that the control device (64) during a road trip or at the end of a field will control the valve (66) in such a manner that the tow-bar (12) will pivot downward or up relative to the frame (10) and/or the soil cultivation tool will be lifted up relative to the frame (10), so that the ground clearance of a soil cultivation tool will be increased.

8. Soil cultivation device according to claim 6 or 7, characterized in that the settings of the hydraulic cylinder (24, 34, 40, 80) for road travel are saved in a memory (72).
